(19) United States
(12) Patent Application Publication
(10) Pub. No.: US 2012/0086643 A1
(43) Pub. Date: Apr. 12, 2012

(54) KEYBOARD DEVICE WITH OPTICALLY ENHANCED DISPLAY OUTPUT

(75) Inventors: Glen C. Larsen, Issaquah, WA (US); Neil Emerton, Redmond, WA (US); Kurt Allen Jenkins, Sammamish, WA (US)

(73) Assignee: MICROSOFT CORPORATION, Redmond, WA (US)

(21) Appl. No.: 12/900,389

(22) Filed: Oct. 7, 2010

(51) Int. Cl. G06F 3/02

(52) U.S. Cl. 345/168; 340/407.2

(57) ABSTRACT

A display and input system configured to receive tactile user input and provide dynamic display output is provided. The system includes a display device and a plurality of input locations situated over the display device. Each of the input locations is at least partially see-through to permit viewing of imagery generated by the display device, where each of the input locations includes an optical element spaced from an operative surface of the display device and configured to adjust viewer perception of image light emanating from the display device through input location. The display and input system may also be implemented to include mechanically-depressible keys providing keyboard-type input functionality.

### BACKGROUND

Keyboards and other peripheral input devices are continually being refined to expand functionality and provide quality user experiences. One area of improvement has been to combine input and output capability in a peripheral device. For example, virtual keyboards have been incorporated using touch interactive displays to provide a more adaptive input experience. In this case, the display capability is provided directly on the keys: each key typically is displayed by the touch interactive display with a legend or symbol that indicates its function. The virtual keyboard approach has many benefits, including the ability to dynamically change the display and function for each key. However, interactive touch displays are often less desirable from a pure input standpoint. Specifically, touch displays do not provide tactile feedback, which can provide a more responsive and agreeable typing experience. Therefore, in many peripheral devices, tradeoffs are made between tactile response and dynamic functionality. Typically, when touch interactivity is provided in connection with a tactile keyboard, the touch interactivity is provided on a different portion of the device and is used for functionality other than keyboard-type inputs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computer peripheral configured to receive tactile user input via mechanical key depression and provide dynamic display output is provided. The computer peripheral includes a display device and a plurality of mechanically-depressible keys situated over the display device. Each of the mechanically-depressible keys is at least partially see-through to permit through-key viewing of imagery generated by the display device. Additionally, each of the mechanically-depressible keys includes an optical element spaced from an operative surface of the display device and configured to adjust viewer perception of image light emanating from the display device through the mechanically-depressible key.

In some embodiments the optical element may include at least one of the following components: a diffuser, a turning film, and a light control film. Specifically in some embodiments a layered construction may be utilized in which two or more of the aforementioned components are included as layers in the optical element. Various viewing characteristics of the computer peripheral may be improved when the aforementioned components are included in the optical element. In particular, the diffuser may'act as a “screen” on which light from the display device is projected. Therefore, the display device may project light onto the diffuser and the diffuser may then scatter the incident light, thereby increasing viewability (e.g., the range of viewing angles) as well as create the perception that the viewable image plane is on or near the top of the key. Moreover, the turning film may improve the ability of a user to see image light projected from the underlying display device by increasing the effective viewable area of display device that may be seen through a particular key. Furthermore, the light control film may provide various benefits, including increased image contrast, suppression of ambient light and, in some implementations, increased privacy by constraining the angle from which the key imagery may be viewed. The improved contrast may be particularly beneficial when a high amount of ambient light is present, such as when the peripheral device is used in an outdoor setting. In this way, the computer peripheral's optical characteristics may be enhanced via the optical element.

### BRIEF DESCRIPTION OF THE DRAWINGS

FIG. 1 depicts an exemplary computing system including a keyboard that provides the ability to display output in connection with the keys of the keyboard.

FIG. 2 shows an illustration of the keyboard of FIG. 1 in which mechanically-depressible keys are attached to a display device.

FIG. 3 depicts an example of the output display capability that may be employed in connection with the keyboard of FIGS. 1 and 2.

FIG. 4 is an exploded cross-sectional view of an example key included in the keyboard shown in FIGS. 1 and 2, with the figure also showing portions of an underlying electrical trace network and display device.

FIG. 5 is a cross-sectional view of an example key and an optical element disposed therein included in the keyboard shown in FIGS. 1 and 2.

FIG. 6 is a cross-sectional view of a light ray projected through an optical element included in an example key included in the keyboard shown in FIGS. 1 and 2.

FIGS. 7-12 show various example constructions of an optical element included in the key shown in FIGS. 5 and 6.

FIG. 13 depicts an exemplary method for making a computer peripheral.

FIG. 14 shows a schematic depiction of a computing system that may be used in connection with the keyboard/peripheral embodiments discussed herein.

### DETAILED DESCRIPTION

The present disclosure is directed to a computer peripheral, such as a keyboard, configured to receive tactile user input via mechanical key depression and provide dynamic display output. The computer peripheral includes a display device and a plurality of mechanically-depressible keys situated over the display device. Each of the mechanically-depressible keys is at least partially see-through to permit through-key viewing of imagery generated by the display device. Each of the mechanically-depressible keys includes an optical element spaced from an operative surface of the display device and configured to: (i) adjust viewer perception of image light emanating from the display device through the mechanically-depressible key and/or (ii) disrupt upwardly-directed collimated light from the display device to enhance oblique-angle through-key viewing of image light from the underlying display.

The optical element may include at least one of the following components: a diffuser, a turning film, and a light control film. Specifically in some embodiments a layered construction may be utilized in which two or more of the aforementioned components are included as layers in the optical element. The component(s) of the optical element may provide several benefits. For example, the diffuser may be configured to scatter light projected from the display device, thereby increasing the viewing angle of the projected imagery as well as creating the perception that the viewable image plane is located at the top of the key. Furthermore, the turning film may increase the viewing angle of the projected imagery allowing a user to view the projected imagery in a number of different postures and/or from various vantage points. Additionally, the light control film may have several benefits such as reducing reflection of ambient light, thereby reducing glare as well as increasing image contrast.

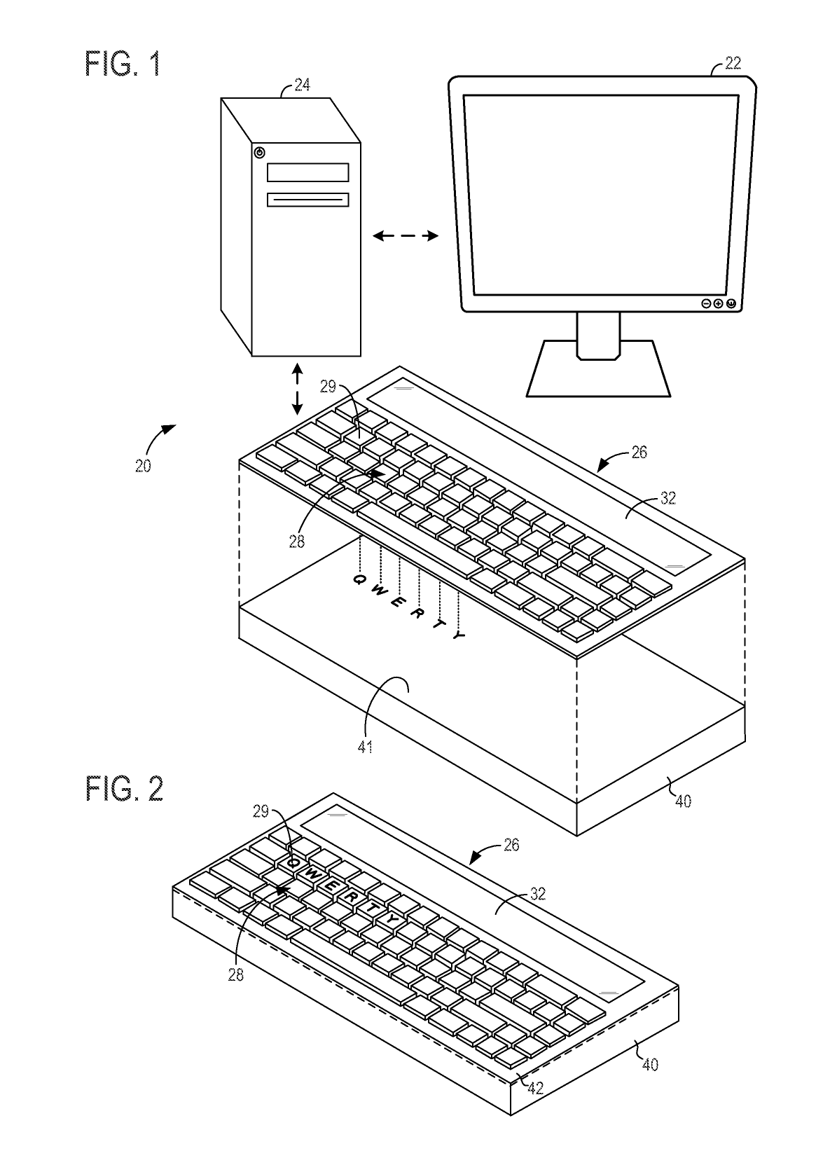

FIG. 1 depicts an exemplary computing system 20 including a display monitor 22 for providing visual output, a computing device in the form of component enclosure 24 (e.g., containing a processor, memory, hard drive, etc.), and a computer peripheral in the form of keyboard 26. Display monitor 22 may be referred to as a primary display. The component enclosure may be in wired/wireless communication with the display monitor and/or the keyboard. FIG. 2 provides an additional view of keyboard 26 and exemplary components that may be used in its construction. As will be described in various examples, keyboard 26 may be implemented to provide displayable output in addition to keyboard-type input functionality.

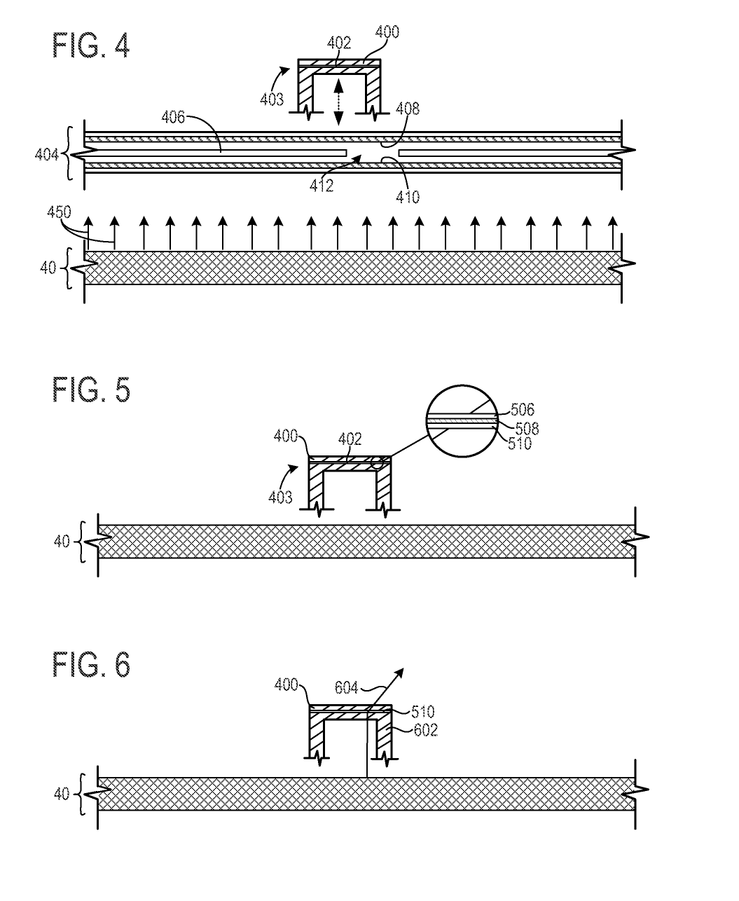

In some examples, displayable output of the keyboard is provided from a suitable display device 40, such as a liquid crystal display (LCD) device, having an operative surface 41. Display device 40 may be referred to as a secondary display. The image light from the display device is viewed through mechanically-depressible keys disposed over the top of the display device. It will be appreciated that each mechanically-depressible key may include a viewing window or be otherwise configured to permit image light from the underlying display device to pass through the keys for viewing by a user. Thus in some examples, each mechanically-depressible key may be at least partially constructed out of a see-through material (e.g., a transparent or partially transparent material), thereby enabling light to be projected through the key. The size and geometry of the viewing window may be selected based on the desired viewing characteristics of the computer peripheral. Specifically, it may be desirable to maximize and optimize the ability to view image light emanating through the keys from the underlying display device, in some examples. However various factors such as the size and geometry of opaque understructures and components {e.g., mechanical understructures (not shown) for providing movement of the mechanically-depressible keys, electrical traces, etc.} may impose constraints on the user's ability to view image light emanating through the keys. Therefore, an optical element configured to enhance through-key viewing may be provided in each of mechanically-depressible keys 28 to at least partially overcome the aforementioned constraints. The optical element is discussed in greater detail herein with regard to FIGS. 4-12.

Continuing with FIG. 1, individual keys may be depressed to provide inputs, for example, in the form of electrical signals to control computing system 20. The terms “input” and “output” will be used frequently in this description in reference to example keyboard embodiments. When used in connection with a keyboard key, the term “input” will generally refer to the input signal that is provided by the keyboard in response to operation of the key. “Output” will generally refer to the display provided for a key, such as the displayed legend, icon, or symbol that indicates the function of the key.

As indicated by the “Q”, “W”, “E”, “R”, “Y”, on keys 28 (FIGS. 1 and 2), it will often be desirable that keyboard 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, keys 28 of the keyboard may be variously configured to provide other inputs. Keys may be assigned, for example, to provide functionality for various languages and alphabets, and/or to activate other input commands for controlling computing system 20. In some implementations, the key functions may adapt and/or change dynamically, for example in response to the changing operational context of software running on computing system 20. For example, upon pressing of an “ALT” key, operation of a key that otherwise is used to enter the letter “F” might instead result in activation of a “File” menu in a software application. Generally, it will be understood that the keys in the present examples may be selectively depressed to produce any type of input signal for controlling a computing device.

Keyboard 26 can provide a wide variety of displayable output. In some examples, the keyboard causes a display of viewable output on or near the individual keys 28 to indicate key function. This can be seen in FIGS. 1 and 2, where instead of keys with letters painted, printed or etched onto a keycap surface, display device 40 (e.g., an LCD device situated under the keys) is used to display the “Q”, “W”, etc., functions of the keys. This dynamic and programmable display capability facilitates potential use of keyboard 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided does not have to be associated with the input functionality of the keyboard. Images might be provided, for example, for aesthetic purposes, to personalize the user experience, or to provide other types of output. The present disclosure encompasses display output for any purpose, including purposes other than to indicate the function of particular keys.

Also, in addition to display provided on or near keys 28, display functionality may be provided in other areas, for example in an area 32 located above keys 28. Still further, area 32 or other portions of keyboard 26 may be provided with touch or gesture-based interactivity in addition to the keyboard-type input provided by keys 28. For example, area 32 may be implemented as an interactive touchscreen display, via capacitive-based technology, resistive-based technology, or other suitable methods. Also, as described elsewhere herein, the portion of the device that underlies the keyboard may also include capabilities in addition to display, including touch sensitivity, machine vision and the like.

Turning now to FIG. 2, keyboard 26 may include underlying display device 40 and a keyboard over-structure 42 disposed over and secured to the display device. The keyboard over-structure may include keys 28, a plurality of mechanical structures which may be disposed under keys, and/or an electrical trace network. Keys 28 are mechanically movable toward and away from underlying display device 40. Underneath keys 28 is an electrical trace network (not visible in the figure) that provides electrical signals in response to depression of keys 28. Alternatively, as mentioned above, output signals may result from touch interaction of the keys with the display device or through other appropriate mechanisms. Specifically, in some examples, output signals may be generated in response to optical sensing of mechanical key depression. In other words, an optical sensing subsystem (not shown) using machine vision may be employed to generate output signals responsive to mechanical key depression.

A variety of types of display devices may be employed in keyboard 26. As indicated briefly above, one type of suitable display device is an LCD device. References to an LCD or other specific type of display device are non-limiting; the keyboard examples discussed herein may include any display type suitable for use with overlying mechanically-depressible keys.

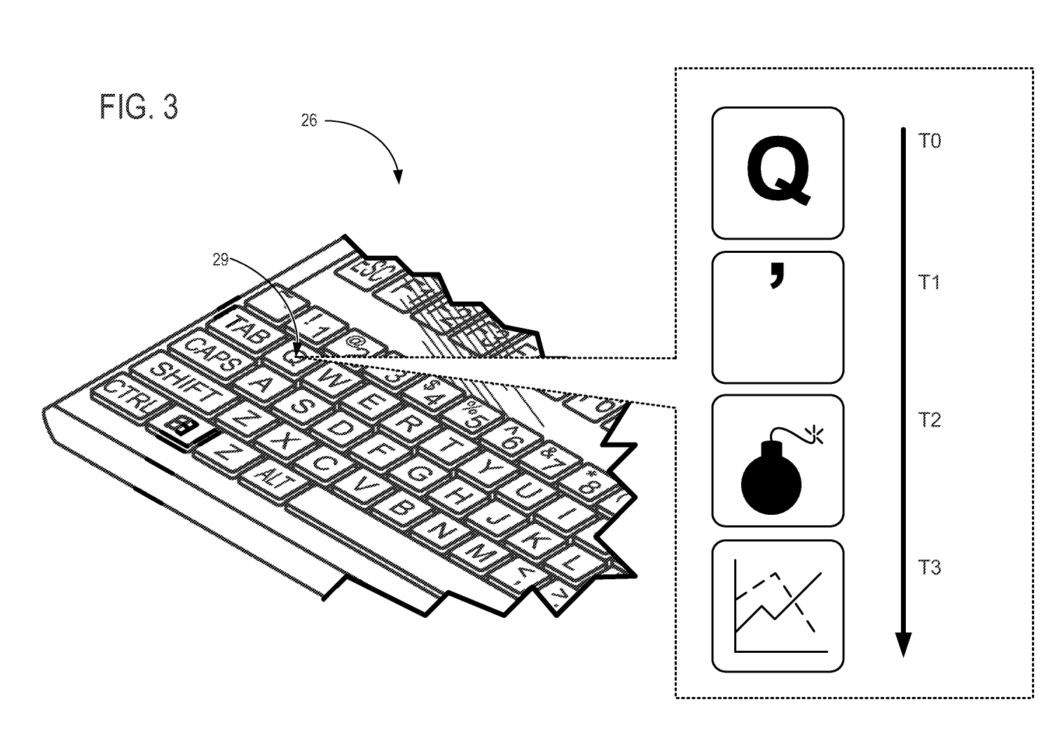

FIG. 3 provides further illustration of how the display capability of keyboard 26 may be employed in connection with an individual key 29. In particular, as shown respectively at times T0, T1, T2, etc., the display output associated with key 29 may be changed, for example to reflect the input command produced by depressing the key. However, as previously mentioned, the viewable output provided by the keyboard may take forms other than displays associated with individual keys and their input functionality.

As indicated above, it will normally be desirable to maximize and optimize the ability to view image light emanating through the keys from the underlying display device. Design goals may include increasing contrast, suppressing ambient light, increasing the viewable area of the underlying display and/or providing privacy through constraining viewing angles, to name a few examples.

To enhance optical performance and/or variously provide the above advantages, each of the mechanically-depressible keys may be provided with an optical element configured to adjust viewer perception of the image light from the display device and/or to disrupt the upwardly-directed collimated light produced by the display device.

FIG. 4 schematically depicts a cross section of a mechanically-depressible key 400 situated over display device 40, the mechanically-depressible key including optical element 402. Optical element 402 may be generally located within or near an upper portion 403 of key 400. It will be appreciated that key 400 provides an example implementation that may be used with some or all of the keys shown in the other figures of the present application. Relative dimensions in the figure are for the purposes of illustration and clarity only; actual dimensions may vary from those in the figure.

In the example of FIG. 4, an electrical trace network 404 is provided below key 400. Depression of the key produces a resilient deformation in which an upper portion 408 of the trace network is brought into contact with a lower portion 410 through a hole 412 in insulating layer 406. The resulting contact causes generation of an output signal associated with the key. It will be understood, however, that this is but one example of how an output signal may be generated. Many other approaches are possible without departing from the scope of the current discussion. For example, an optical sensing subsystem using machine vision may be used to detect key actuation. The figure also shows upwardly-directed image light 450 emanating from display device 40. This image light passes through the key to provide through-key viewing of image light, such as, for example, a display indicating the function of the key.

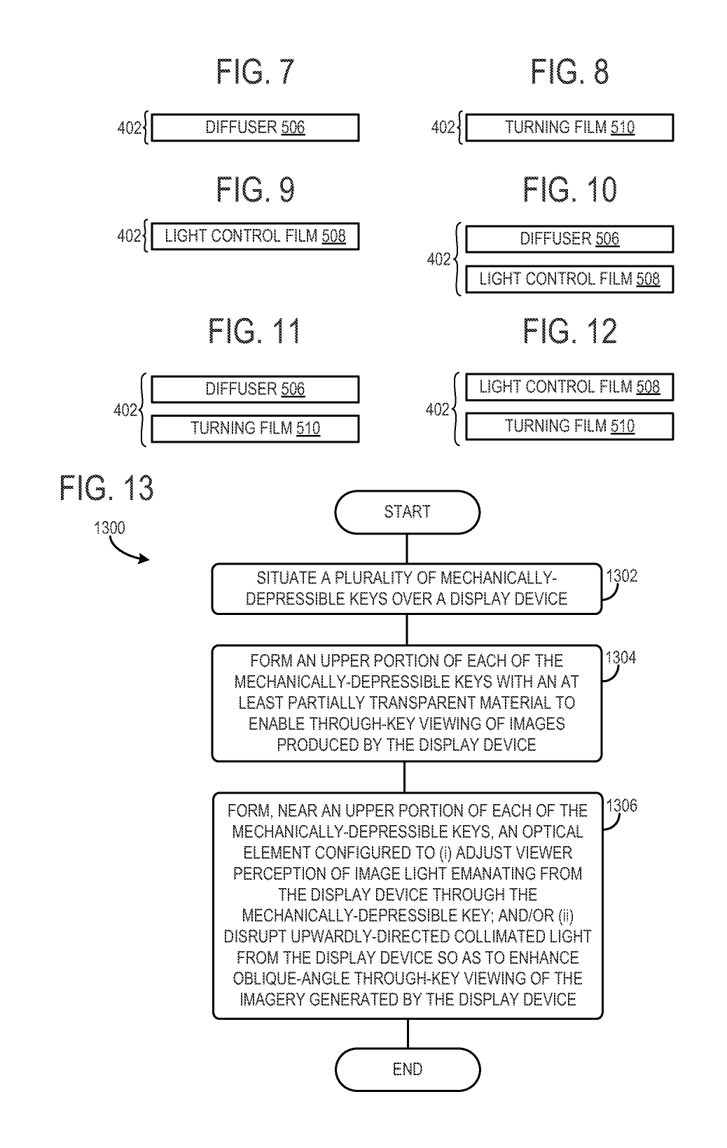

As briefly mentioned above, an upper portion of the key may include an optical element to enhance through-key viewing of image light. Specifically as indicated in FIG. 4 and in more detail in FIG. 5, optical element 402 may be generally located within or near upper portion 403 of key 400. FIG. 5 shows that the optical element may be formed in a layered construction, including a diffuser 506, light control film 508 and turning film 510. As shown, the diffuser is positioned above the light control film which is positioned above the turning film. However, the number as well as the stacking order of the layers may be altered in other examples, discussed in greater detail with regard to FIGS. 7-12. These layers may be formed using any appropriate manufacturing method or technique, such as molded, adhesively bonded, ultrasonically welded, etc. Moreover, the layers (i.e., diffuser, light control film, and turning film) may be disposed in various locations near the upper portion of the key. Though the specific location and structure may vary, it typically will be desirable that the layer or layers (in some cases, there may be only one or two of the depicted layers) be positioned at a location spaced away from operative surface 41 of the underlying display device 40, shown in FIG. 1. However, in other examples one or more of the layers may be disposed on or near operative surface 41 of display device 40, shown in FIG. 1, while one or more of the other layers may be spaced away from the operative surface and positioned in key 400. In such a configuration, the layer(s) disposed on or near the operative surface may optically interact with the layer(s) spaced away from the operative surface to provide enhanced optical capabilities, discussed in greater detail herein.

The depicted layers may provide various advantages in connection with improving the user viewing experience of images produced by the underlying display device. For example, diffuser 506 enables the system to act as a projection device in which the diffuser provides a “screen” onto which light from the display device is projected. The incident collimated light is then scattered, increasing viewability (e.g., range of viewing angles) and creating the perception that the viewable image plane is located on the plane of the diffuser, near the top of the key. In this way the diffuser is configured to disrupt upwardly-directed collimated light from the display device so as to enhance oblique-angle through-key viewing of the imagery generated by the display device.

The light control film 508 may provide various benefits, including increasing image contrast, suppressing ambient light and, in some implementations, increasing privacy by constraining the viewing angle that enables a user to see the images passing through the keys. The light control film acts like a venetian blind in which the slats are oriented at a particular angle, thereby favoring transmission in certain directions while absorbing other light. In certain implementations, this suppresses ambient light and/or provides improved contrast. Improved contrast may be particularly beneficial when a high amount of ambient light is present, such as when the peripheral device is used outdoors. Privacy may also be obtained through use of the light control film by limiting viewing angles from which images from display device 40 may be seen.

Turning film 510 may improve the ability of a user to see image light from the underlying display device by increasing the effective viewable area of display device that may be seen through a particular key. In particular, the typical vantage point of the user is at an angle to the planar expanse of display device. This angle will vary depending on the user's position, and may range from a few degrees to 45 degrees or more, such as when the keyboard is situated on a desk in front of the user. In this arrangement, the turning film refracts the incident light toward the user's eye. This bending effect allows the user to see portions of the display device that otherwise would be obscured, for example by a front wall of one of the mechanically-depressible keys. Moreover, the refraction angle of the turning film may be selected to enable a user to maintain an ergonomic posture while viewing the imagery projected from the underlying display device as well as executing mechanical key inputs (e.g., depression of the keys). Further, it will be appreciated that the angle of refraction in turning film 510 may also be selected based on the end use of the device. For example, different angles may be used for a computer peripheral integrated into a component enclosure of a laptop computer as opposed to a computer peripheral used in conjunction with a desktop computer. In this way, the optical element may be adapted for use with a variety of computer peripherals.

FIG. 6 schematically shows use of turning film 510 to enable viewing of image light that would otherwise be obscured by front wall portion 602 of the depicted key structure. In some examples (not shown), the feature labeled turning film 510 may be a single turning prism. However, in other examples turning film 510 may include a plurality of microprisms or other suitable structures configured to refract light. Although the optical element is shown only including a turning film it will be appreciated that additional or alternative layers may be included in the optical element, as described below. As shown the angle of light ray 604 may be refracted when projected through key 400, thereby enabling viewing of image light at a different angle.

It will be further understood that different applications may call for different layered configurations of optical element 402 shown in FIGS. 4 and 5, including single-layer implementations, as shown in FIGS. 7-9. FIG. 7 shows the optical element including diffuser 506 only, FIG. 8 shows the optical element including turning film 510 only, and FIG. 9 shows the optical element including a light control film 508 only. Example dual layer implementations are shown in FIGS. 10-12. Specifically FIG. 10 shows the optical element including diffuser 506 and light control film 508, FIG. 11 shows the optical element including diffuser 506 and turning film 510, and FIG. 12 shows the optical element including light control film 508 and turning film 510. As previously discussed a triple layer implementation may be utilized as shown in FIG. 5. Moreover, in the dual and triple layers configurations the layers may be positioned in any suitable stacking sequence. The arrangement of the layers may be selected to achieve varying benefits. For example, privacy considerations may dictate using the light control film as the top-most layer, to maximize its angle-selective transmission. In another example, the diffuser may be positioned above other layers in the optical element, to prevent the diffuse light from optically interfering with the optical characteristics of the other layers. Specifically, the diffuser may be the top-most layer. Moreover, the turning film may be the layer positioned closest to the display device, due to the fact that the turning film may not significantly affect the optical characteristics of the other layers.

Various manufacturing techniques may be employed for optical element 402. The various layers may be bonded through ultrasonic or pressure-sensitive adhesive methods; formed through printing, deposition or other like techniques; and/or formed using molding processes, including co-molding, overmolding or unified molding processes. The layers may be affixed to a separate transparent layer or portion, such as a keycap made of polycarbonate or acrylic (for example), or may be formed without a separate transparent material. Moreover, one or more layers within the optical element may be embossed. Specifically the turning film may be micro-embossed.

It will be further appreciated that the present disclosure contemplates a method of making a computer peripheral, such as an interactive keyboard with dynamic display output and through-key viewing in connection with mechanically-depressible keys. Such a method might include, as shown in connection with exemplary method 1300 of FIG. 13, situating a plurality of mechanically-depressible keys over a display device (step 1302). The method may further include forming an upper portion of each of the mechanically-depressible keys with an at least partially transparent material to enable through-key viewing of images produced by the display device, as shown at 1304. Finally the method may include at 1306, forming, near an upper portion of each of the keys, an optical element to (i) adjust viewer perception of image light and/or (ii) disrupt upwardly-directed collimated light from the underlying display device to enhance oblique-angle through-key viewing of the imagery generated by the display device. The optical element may include at least one of a diffuser, a turning film, and a light control film, to optically enhance the computer peripheral as previously discussed. In this way, a computer peripheral with enhanced viewing characteristics may be constructed.

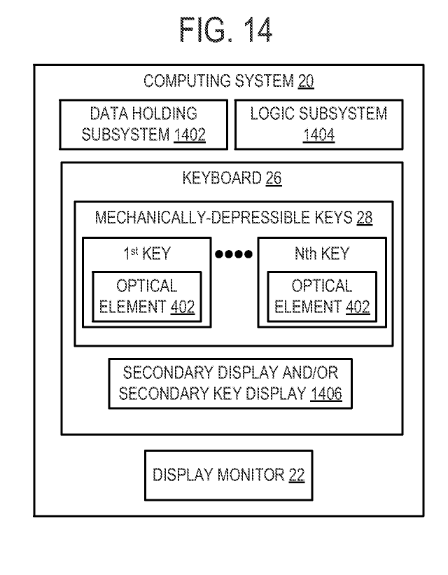

FIG. 14 schematically shows a nonlimiting computing system 20 having a computer peripheral including a display device underlying a plurality of mechanically-depressible keys, each key including an optical element. Computing system 20 is shown in simplified form. It is to be understood that virtually any computer architecture may be used without departing from the scope of this disclosure. In different embodiments, computing system 20 may include a mainframe computer, server computer, desktop computer, laptop computer, tablet computer, home entertainment computer, network computing device, mobile computing device, mobile communication device, gaming device, etc. Computing system 20 may also include computer peripherals such as keyboards, mice, game controllers, cameras, microphones, and/or touch screens, for example.

Specifically, exemplary computing system 20, as shown in FIG. 14, may include a data-holding subsystem 1402 containing instructions executable by a logic subsystem 1404 to control the display outputs of mechanically-depressible keys and appropriately respond to input signals generated as a result of key activation.

Logic subsystem 1404 may also include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 1404 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 1402 may include one or more physical, non-transitory devices configured to hold data and/or instructions executable by the logic subsystem to implement the methods and processes described herein. When such methods and processes are implemented, the state of data-holding subsystem 1402 may be transformed (e.g., to hold different data).

Data-holding subsystem 1402 may include removable media and/or built-in devices. Data-holding subsystem 1402 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 1402 may include devices with one or more of the following characteristics: volatile, nonvolatile, dynamic, static, read/write, read-only, random access, sequential access, location addressable, file addressable, and content addressable. In some embodiments, logic subsystem 1404 and data-holding subsystem 1402 may be integrated into one or more common devices, such as an application-specific integrated circuit or a system on a chip. As discussed above, the data-holding subsystem may be in the form of removable computer-readable storage media, which may be used to store and/or transfer data and/or instructions executable to implement the methods and processes described herein. Removable computer-readable storage media may take the form of CDs, DVDs, HD-DVDs, Blu-Ray Discs, EEPROMs, and/or floppy disks, among others.

Computing system 20 may include a computer peripheral such as keyboard 26. The computer peripheral may be configured to receive tactile user input via mechanical key depression and provide dynamic display output. As discussed above the computer peripheral may include a display device, such as secondary display and/or secondary key display 1406, and plurality of mechanically-depressible keys 28 situated over the display device. Each of the mechanically-depressible keys may be at least partially see-through to permit through-key viewing of imagery generated by the display device. It will be appreciated that the secondary display and/or secondary key display 1406 may be similar to display device 40, shown in FIGS. 1 and 2. The primary display may be display monitor 22 or a display device included in keyboard 26 spaced away from the mechanically-depressible keys. However, in other examples the computing system may not include a display monitor.

Additionally, each of the mechanically-depressible keys may include optical element 402 spaced from an operative surface of the display device and is configured to adjust viewer perception of image light emanating from the secondary display through the mechanically-depressible key. Optical element 402 may include at least one of a diffuser, a turning film, and a light control film. Specifically in some examples, a multi-layer construction may be utilized in which two or more of the aforementioned optical components (i.e., diffuser, turning film, light control film) are utilized.

The terms “module,” “program,” and “engine” may be used to describe an aspect of computing system 20 that is implemented to perform one or more particular functions. In some cases, such a module, program, or engine may be instantiated via logic subsystem 1404 executing instructions held by data-holding subsystem 1402. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A display and input system configured to receive tactile physically-applied user input and provide dynamic display output, comprising:
a display device, and
a plurality of input locations situated over the display device, each of the input locations being at least partially see-through to permit viewing, through the input locations, of imagery generated by the display device, where each of the input locations includes an optical element spaced from an operative surface of the display device and configured to adjust viewer perception of image light emanating from the display device through the input location.

2. The display and input system of claim 1, where the optical element includes a diffuser.

3. The display and input system of claim 2, where the optical element has a layered construction including the diffuser and a turning film.

4. The display and input system of claim 3, where the turning film is disposed between the display device and the diffuser.

5. The display and input system of claim 3, where each of the input locations corresponds to an upper surface of a mechanically-depressible key that is situated over the display device and that is at least partially see-through to permit through-key viewing of imagery from the display device, the display and input system thereby being configured as a computer peripheral having mechanical keyboard-type input functionality in addition to output display functionality.

6. The display and input system of claim 3, where the optical element further includes a light control film.

7. The display and input system of claim 6, where the light control film is situated between the diffuser and the turning film, with the turning film being a layer that is closest to the display device.

8. The display and input system of claim 2, where the optical element has a layered construction including the diffuser and a light control film.

9. The display and input system of claim 1, where the optical element includes a light control film.

10. The display and input system of claim 9, where the optical element has a layered construction including the light control film and a turning film.

11. The display and input system of claim 10, where the light control film is disposed between the display device and the turning film.

12. The display and input system of claim 10, where the turning film is disposed between the display device and the light control film.

13. The display and input system of claim 1, where the optical element includes a turning film.

14. A computer peripheral configured to receive tactile user input via mechanical key depression and provide dynamic display output, comprising:
a display device, and
a plurality of mechanically-depressible keys situated over the display device, each of the mechanically-depressible keys being at least partially see-through to permit through-key viewing of imagery generated by the display device, where each of the mechanically-depressible keys includes, at an upper portion of the key, an optical element containing a diffuser configured to disrupt upwardly-directed collimated light from the display device so as to enhance oblique-angle through-key viewing of the imagery generated by the display device.

15. The computer peripheral of claim 14, where the optical element has a layered construction including the diffuser and a turning film.

16. The computer peripheral of claim 15, where the optical element further includes a light control film.

17. The computer peripheral of claim 16, where the light control film is disposed between the diffuser and the turning film, with the turning film being a layer that it closest to the display device.

18. The computer peripheral of claim 14, where the optical element has a layered construction including the diffuser and a light control film.

19. A method of making a computer peripheral, comprising:
situating a plurality of mechanically-depressible keys over a display device; forming an upper portion of each of the mechanically-depressible keys with an at least partially transparent material to enable through-key viewing of images produced by the display device; and
forming, near the upper portion of each of the mechanically-depressible keys, an optical element configured to adjust viewer perception of image light emanating from the display device through the mechanically-depressible key.

20. The method of claim 19, wherein the optical element includes at least one of a diffuser, a turning film, and a light control film.
